(19) United States
(12) Patent Application Publication
(10) Pub. No.: US 2007/0114210 A1
(43) Pub. Date: May 24, 2007

(54) Device for preparing a multilayer printed circuit board for the drilling of contact bores

(76) Inventor: Alfred Reinhold, Wunstorf (DE)

Correspondence Address: SHLESINGER, ARKWRIGHT & GARVEY LLP, 1420 KING STREET, SUITE 600, ALEXANDRIA, VA, 22314, US

(21) Appl. No.: 11/594,253

(22) Filed: Nov. 8, 2006

(30) Foreign Application Priority Data
Nov. 8, 2005 (DE) 10 2005 053 202.0

(51) Int. Cl. B23K 26/00

(52) U.S. Cl. 219/121.7; 219/121.83

(57) ABSTRACT

Device for preparing a multilayer printed circuit board for the drilling of contact bores, which contact bores connect the contact surfaces of at least a first layer of the multilayer printed circuit board to contact surfaces of at least a second layer of the multilayer printed circuit board. The device for preparing a multilayer printed circuit board for the drilling of contact bores includes a device for determining a layer offset between the at least a first layer and the at least a second layer of the multilayer printed circuit board. The device for preparing a multilayer printed circuit board includes a device for applying at least one reference mark to the multilayer printed circuit board, and a device for determining drilling coordinates for the contact bores in relation to the at least one reference mark and based upon the determined layer offset.

### CROSS-REFERENCE TO RELATED APPLICATIONS

This application claims priority of German Application No. 10 2005 053 202.0, filed Nov. 8, 2005, and which is incorporated herein by reference.

### FIELD OF THE INVENTION

The invention relates to a device for preparing a multilayer printed circuit board for the drilling of contact bores, which contact bores connect contact surfaces of at least a first layer of the multilayer printed circuit board and contact surfaces of at least a second layer of the multilayer printed circuit board to one another.

### BACKGROUND OF THE INVENTION

With the trend toward increasing miniaturization of electronic subassemblies, it is necessary to provide an ever greater number of components or printed conductors on a given surface, for example a printed circuit board. For this reason, the process of configuring printed circuit boards as so-called multilayer printed circuit boards is known, in which the printed circuit board includes a multitude of individual printed circuit boards arranged in layers one on top of another, so that components or printed conductors can be arranged on the front and back sides of the individual printed circuit boards, and thereby, due to the layered construction, also between the individual sequential printed circuit boards in the layering. In this manner it is possible especially to realize printed circuit boards having a particularly large number of printed conductors, which could not be accommodated on a single printed circuit board. The individual printed circuit boards, whose layering forms a multilayer printed circuit board, are securely connected to one another, for example via pressing or adhesion.

In order to achieve a transmission of electrical signals, for example between a first layer and a second layer of the multilayer printed circuit board, it is necessary to connect the printed conductors of the layers to one another in such a way that they are electrically conductive. To this end, the layers include contact surfaces, also referred to as pads. The contact surfaces can be arranged, for example, on the layers, one on top of another, perpendicular to the printed circuit board plane of the multilayer printed circuit board. For the electrically conductive connection of the contact surfaces, contact bores are drilled, wherein the contact bores connect the contact surfaces to one another mechanically, such that the electrically conductive connection can be produced by making the inner walls of the contact bores electrically conductive using solder or some other electrically conductive material.

In this manner, the contact bores must be structured such that an electrically conductive contact between the contact surfaces is achieved in the desired manner. This can be achieved without further steps if the contact surfaces are arranged precisely one on top of another, perpendicular to the printed circuit board plane of the multilayer printed circuit board. However it must be taken into consideration that in connecting the layers of the multilayer printed circuit board, for example via pressing, a high level of surface pressure combined with high temperatures are used. As a result, in the connection of the layers, a layer offset can occur between the layers. This type of layer offset can be caused by the individual layers shrinking or expanding and/or shifting relative to one another parallel to the plane of the printed circuit board and/or rotating relative to one another around an axis that extends perpendicular to the plane of the printed circuit board.

When a layer offset occurs in this manner, it is no longer possible to form the electrically conductive connection between the contact surfaces of the layers via the contact bores, if the layer offset exceeds preset tolerances. The printed circuit board must then be discarded as scrap.

In order to prevent printed circuit boards in which the layer offset exceeds preset tolerances from undergoing costly further processing, for example being loaded with components, it is known from DE 33 42 564 C2 to determine the layer offset using an x-ray measuring instrument.

A known drilling apparatus for drilling contact bores for use in connecting contact surfaces of at least a first layer of a multilayer printed circuit board with contact surfaces of at least a second layer of the multilayer printed circuit board has a drilling device for drilling the contact bores and a control device for generating control signals for actuating the drilling device in accordance with the respective contact bores to be drilled. To secure the multilayer printed circuit board, hereinafter shortened to printed circuit board, in the drilling apparatus, the printed circuit board is equipped with mounting holes, with which it can be placed on corresponding mounting pins provided on a base, for example a drilling machine table, of the drilling apparatus. Thus the position of the printed circuit board relative to the base is determined by the position of the mounting holes.

In this connection, the process of correcting the position of the mounting holes in the printed circuit board to compensate for any layer offset that has occurred is known. To accomplish this, the printed circuit board is placed in an x-ray measuring device, so that any layer offset among the layers of the printed circuit board can be detected, as is known, for example, from DE 33 42 564 C2. If a layer offset is detected, the position of the mounting holes can be selected such that the layer offset is completely or partially compensated for in the subsequent drilling of the contact bores, as long as the layer offset lies within certain limits.

Once the layer offset has been determined and the mounting holes have been drilled in the printed circuit board, the printed circuit board is removed from the x-ray measuring device and is placed in the drilling apparatus, where it is placed on the mounting pins of the base. The drilling device of the drilling apparatus then drills the desired contact bores.

### OBJECTS AND SUMMARY OF THE INVENTION

An object of the invention is to overcome the drawbacks of the prior art.

An object of the invention is to provide a device for preparing a multilayer printed circuit board for the drilling of contact bores, which contact bores connect contact surfaces of at least a first layer of the multilayer printed circuit board and contact surfaces of at least a second layer of the multilayer printed circuit board to one another, and with which in the subsequent drilling of the contact bores in a drilling apparatus, the positioning precision of the contact bores is increased.

This object is achieved with the teachings according to the invention as set forth herein, and in the claims.

The basic idea of the teaching according to the invention includes determining the drilling coordinates for the contact bores in relation to a preferably and especially optically detectable reference mark, which can be applied using a suitable device to the multilayer printed circuit board, which hereinafter is also shortened to printed circuit board. Thus according to the invention, the drilling coordinates are no longer absolutely defined, for example in correspondence with a system of coordinates for the drilling apparatus; rather they are defined in relation to the reference mark. The result, according to the invention, is that the drilling coordinates clearly define the position of the desired contact bores in relation to the reference mark, even after any changes in the position of the printed circuit board. Thus once the reference mark has been detected, the contact bores can be drilled using the drilling coordinates.

In this manner, the position of the contact bores is no longer dependent upon mechanical tolerances, which in the prior art affect the positioning precision of the contact bores in the drilling of the mounting holes and in the placement of the printed circuit board on the mounting pins on a base of a drilling apparatus. In this manner, the positioning precision of the contact bores is increased substantially.

In the formation of contact bores in a printed circuit board, the board is first prepared for the drilling of the contact bores in a device according to the invention, by first determining a layer offset between the layers of the multilayer printed circuit board. At least one reference mark is then applied to the printed circuit board. The drilling coordinates for the contact bores are then determined in relation to the reference mark and based upon the determined layer offset.

The printed circuit board can then be removed from the device according to the invention and placed in a drilling apparatus. In the drilling apparatus, first the position of the reference mark or the reference marks is detected. A drilling device of the drilling apparatus is then controlled using control signals, which contain the drilling coordinates in relation to the reference mark determined in the device according to the invention, such that the drilling device drills the contact bores in relation to the detected position of the reference mark.

The size and number of the reference mark or the reference marks can be selected from within a wide range of possibilities. According to the invention it is sufficient, in principle, for a single reference mark to be applied to the printed circuit board. However it is also possible according to the invention to apply multiple reference marks spaced from one another along the surface of the printed circuit board. In such an embodiment it is especially possible, according to the invention, in the preparation of the printed circuit board to determine the spacing of the reference marks in relation to one another. Once the reference marks have been detected and their spacing from one another has been determined, it can be determined, for example in a drilling device, whether the distance between the reference marks has changed, in other words whether expansion, shrinkage or some other type of change in the printed circuit board has occurred. The drilling coordinates can then be corrected to account for the detected change. If, in contrast, it is determined that the position of the reference marks in relation to one another and/or their size has not changed, the drilling coordinates in relation to the reference mark can be used without correction to drill the contact bores.

The shape of the reference mark or the reference marks can also be selected from a wide range of possibilities. For example, line markings or geometric patterns can be used as reference marks. Using a rotationally symmetrical reference mark, the rotational position of the printed circuit board perpendicular to the printed circuit board plane can especially be determined.

According to the invention, the device for applying at least one reference mark can be configured in any suitable manner. One extraordinarily advantageous further development of the teaching according to the invention provides that the device for applying at least one reference mark has at least one laser, whose laser beam can be used to apply the reference mark to the multilayer printed circuit board. Suitable marking lasers are commercially available as relatively simple and cost-effective standard components. They enable a highly precise marking of the printed circuit board with the reference mark.

The reference mark used according to the invention can be detected in any suitable manner. For example, an electrically or mechanically detectable marking can be used. However, one extraordinarily advantageous further development of the teaching according to the invention provides that at least one reference mark is an optically detectable marking. In this manner the detection of the reference mark is particularly simple in design.

In principle it is possible according to the invention to apply the reference mark to the interior of a multilayer printed circuit board. In order for the detection of the reference mark to be particularly simple and efficient, one advantageous further development of the teaching according to the invention provides that the device for applying at least one reference mark applies the reference mark or the reference marks to the surface of the multilayer printed circuit board.

Another advantageous further development of the teaching according to the invention provides that the device for determining a layer offset uses an imaging process to determine the layer offset.

In order for the determination of the layer offset to be particularly precise and efficient, one advantageous further development of the aforementioned embodiment provides that the device for determining the layer offset has at least one x-ray measuring device for measuring the layer offset, wherein according to one advantageous further development, the x-ray measuring device has at least one microfocus x-ray tube.

The drilling coordinates determined according to the invention can be two-dimensional coordinates, which define the position of the contact bores in an x- and a y-direction along the surface of the printed circuit board. However they can also be three-dimensional coordinates, which, in addition to the position of the contact bores in an x- and a y-direction, for example also define the depth of the respective contact bore.

One drilling apparatus provided especially for use with the device according to the invention for the drilling of contact bores is disclosed herein.

According to the invention, the drilling apparatus includes a device for detecting the position of at least one reference mark applied to the multilayer printed circuit board, wherein the control device controls the drilling device using control signals that contain the drilling coordinates for the contact bores in relation to the reference mark, such that the drilling device drills the contact bores in relation to the detected position of the reference mark. The drilling apparatus according to the invention thus enables the drilling of the contact bores with a high positioning precision, and with the complete or the greatest possible exclusion of mechanical tolerances.

One advantageous further development of the drilling apparatus according to the invention provides that the sensor device has at least one optical sensor for detecting an optically detectable marking, wherein the optical sensor is preferably formed by a camera. In these embodiments, the detection of the reference mark or the reference marks is enabled with a particularly high level of precision at a low level of instrumentation expenditure.

One extraordinarily advantageous further development of the drilling apparatus according to the invention provides that the drilling device includes at least one laser for drilling the contact bores. Using a laser, the contact bores can be drilled particularly rapidly, with a particularly high level of precision.

One system according to the invention for drilling contact bores for connecting contact surfaces of at least a first layer of a multilayer printed circuit board with contact surfaces of at least a second layer of the multilayer printed circuit board includes a device for preparing a multilayer printed circuit board and a drilling apparatus for drilling contact bores for connecting surfaces of at least a first layer of a multilayer printed circuit board with contact surfaces of at least a second layer of a multilayer printed circuit board, as described herein.

The system includes at least a device for preparing a multilayer printed circuit board for the drilling of contact bores, which contact bores connect a contact surface of at least a first layer of the multilayer printed circuit board and a contact surface of at least a second layer of the multilayer printed circuit board to one another, and a drilling apparatus for drilling the contact bores for connecting the contact surfaces of the at least a first layer of the multilayer printed circuit board with the contact surfaces of the at least a second layer of the multilayer printed circuit board, the drilling apparatus including a drilling device provided for drilling the contact bores, and a control device provided for generating control signals for controlling the drilling device in accordance with the respective contact bores to be drilled; and the system further including a device provided for detecting the position of the at least one reference mark applied to the multilayer printed circuit board.

In the system according to the invention, the device for determining the drilling coordinates for the contact bores in relation to the reference mark is in signal transmission connection with the control device, and transmits to the control device a data set for a multilayer printed circuit board that is to be processed, which contains the drilling coordinates for the contact bores in relation to the reference mark. According to the invention, the control device controls the drilling device using the drilling coordinates in such a way that the drilling device drills the contact bores in relation to the detected position of the reference mark. In the system according to the invention, the device for preparing the multilayer printed circuit board and the drilling apparatus are preferably separate devices, spatially separated from one another.

Below, the invention will be described in greater detail with reference to the attached, highly schematic set of drawings, which represent an exemplary embodiment of a drilling apparatus according to the invention for performing the process according to the invention. In this manner, all claimed or described characterizing features, and those represented in the drawings, alone or in any combination, achieve the object of the invention, regardless of their combination in the patent claims or their references to other claims, and regardless of their formulation or representation in the description or in the drawings.

Relative terms such as left, right, up, and down are for convenience only and are not intended to be limiting.

### BRIEF DESCRIPTION OF THE DRAWINGS

FIG. 1 is a perspective, highly schematic representation of the layers of a multilayer printed circuit board prior to connection of the layers to one another,

FIG. 2 is a vertical section through the printed circuit board of FIG. 1, wherein for purposes of illustration only two layers are shown and wherein one contact bore is shown, the interior wall of which is provided with an electrically conductive material,

FIG. 3 is a plan view of the printed circuit board according to FIG. 2, without a layer offset of the layers of the printed circuit board relative to one another,

FIG. 4 is in the same representation as in FIG. 3, the printed circuit board according to FIG. 2 with a first layer offset of the layers relative to one another,

FIG. 5 is in the same representation as in FIG. 3, the printed circuit board according to FIG. 2 with a second layer offset of the layers relative to one another,

FIG. 6 is a schematic side view showing a principle of a device according to the invention for preparing a multilayer printed circuit board for the drilling of contact bores,

FIG. 7 is a schematic plan view of a multilayer printed circuit board provided with reference marks,

FIG. 8 is in the same representation as in FIG. 6, a drilling apparatus according to the invention for drilling contact bores, and

FIG. 9 is a signal flow chart for a system according to the invention, including a device according to FIG. 6 and a drilling apparatus according to FIG. 8.

### DETAILED DESCRIPTION OF THE INVENTION

In the drawing figures, equivalent or corresponding components are provided with the same reference symbols.

In FIG. 1 a multilayer printed circuit board 2, hereinafter referred to as a printed circuit board, is represented in a highly schematic fashion. The printed circuit board 2 has a layered construction, wherein layers 4, 6, 8 of the printed circuit board 2 each include a single printed circuit board. The layers 4, 6, 8 of the printed circuit board 2 are securely connected to one another, for example via pressing or adhesion. For purposes of illustration, the layers 4, 6, 8 in FIG. 1 are shown in a state in which they are not connected to one another. Purely by way of example, the printed circuit board 2 in FIG. 1 includes three layers. However the number of layers can be chosen from a wide range of possibilities. For example, the printed circuit board 2 can include only two layers, or of more than three layers.

When the printed circuit board 2 is in its finished state, the layers 4, 6, 8 have printed conductors, wherein in FIG. 1 a printed conductor on the layer 4 is provided with a reference symbol 10, a printed conductor on the layer 6 is provided with a reference symbol 12, and a printed conductor on the layer 8 is provided with a reference symbol 14. The printed conductors 10, 12, 14 are made of an electrically conductive material and are connected with contact surfaces 16 or 18 or 20, respectively, made of electrically conductive material, which in this exemplary embodiment are structured to be essentially circular from a plan view. The contact surfaces 16, 18, 20 can be connected to one another via a contact bore, which in FIG. 1 is indicated by a reference symbol 22.

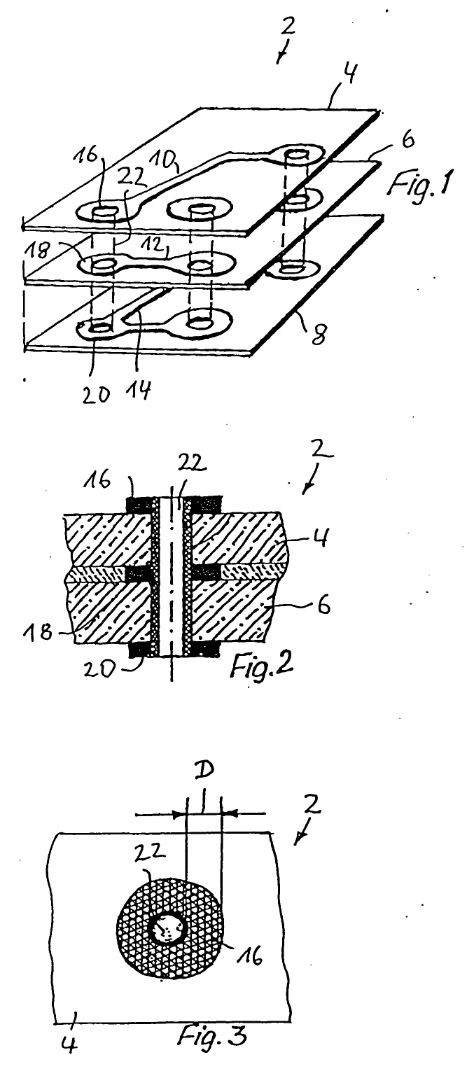

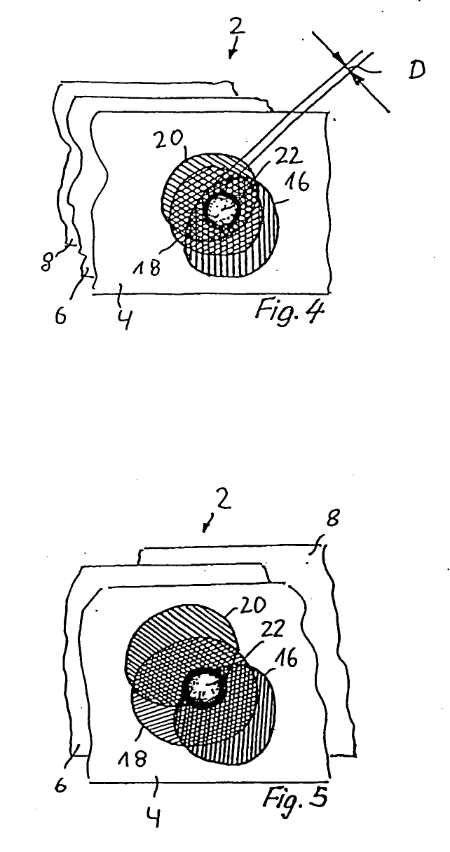

FIG. 2 shows a vertical section through the printed circuit board 2 according to FIG. 1. For the electrically conductive connection of the contact surfaces 16, 18, 20, the printed circuit board 2 is drilled through such that the contact bore 22 ideally extends coaxially to the contact surfaces 16, 18, 20. Once the contact bore 22 has been drilled, its interior wall is provided with an electrically conductive material, for example a solder, which produces an electrically conductive connection between the contact surfaces 16, 18, 20 in the desired manner.

FIG. 3 shows a plan view of the printed circuit board 2 according to FIG. 2. In the connection of the layers 4, 6, 8 to one another, a layer offset of the layers 4, 6, 8 relative to one another can occur, whereby the contact surfaces 16, 18, 20 then no longer lie precisely one on top of another, perpendicular to the plane of the printed circuit board, in the desired manner. A layer offset can occur especially as a result of an expansion or shrinkage of at least one of the layers 4, 6, 8, as a result of a shifting of the layers 4, 6, 8 relative to one another parallel to the printed circuit board plane, and/or as a result of a rotation of the layers 4, 6, 8 relative to one another around an axis that extends perpendicular to the printed circuit board plane, and/or as a result of shear. FIG. 3 illustrates a printed circuit board 2, in which this type of layer offset has not occurred, so that the contact surfaces 16, 18, 20 lie in sequence, one on top of another, perpendicular to the plane of the printed circuit board. As is apparent in FIG. 3, the contact surfaces 16, 18, 20 are essentially ring-shaped following formation of the contact bore 22, wherein in this case the contact bore 22 extends in the desired manner, coaxially to the contact surfaces 16, 18, 20. The ring-shaped contact surfaces 16, 18, 20 have a radial width D.

FIG. 4 illustrates a printed circuit board 2 in which a layer offset has occurred, as a result of which the contact bore 22 is no longer coaxial relative to all of the contact surfaces 16, 18, 20. In this manner, the position of the contact bore 22 is selected such that for all the contact surfaces 16, 18, 20 the greatest possible remaining radial width D results. If the remaining radial width D of the contact surfaces 16, 18, 20 is below a pre-determined value, then the printed circuit board 2 can no longer be used and must be discarded.

FIG. 5 illustrates a printed circuit board 2, in which a layer offset has occurred that is so great that, even after an optimization of the position of the contact bore 22, it cannot be ensured that all the contact surfaces 16, 18, 20 will be ring-shaped with a predetermined minimal radial width. Instead, in the printed circuit board illustrated in FIG. 5, the contact surfaces 16, 18 are no longer ring-shaped following the drilling of the contact bore, rather they are interrupted at their outer circumference in a radial direction. Such a printed circuit board also can no longer be used, and must instead be discarded.

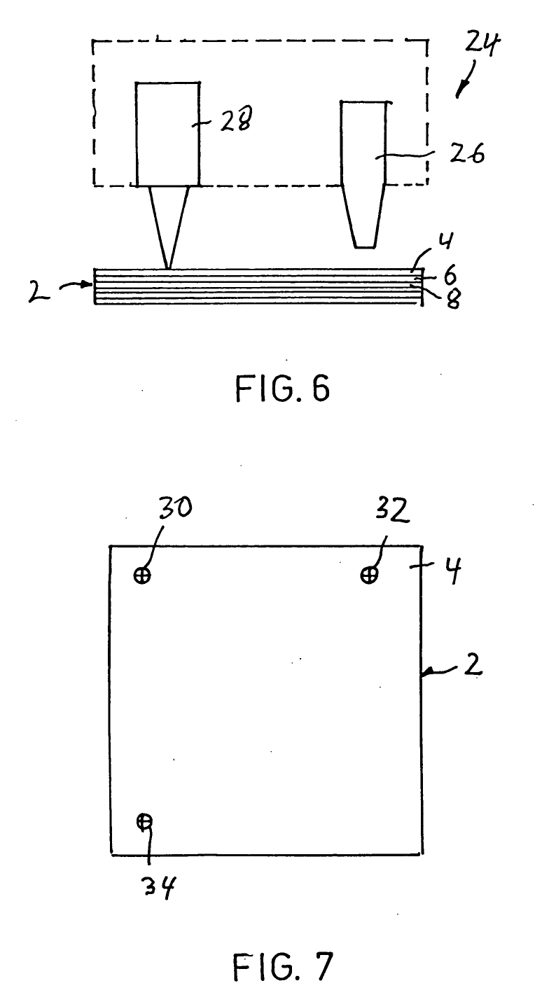

In FIG. 6, a schematic illustration of a principle of a device 24 according to the invention for preparing a multilayer printed circuit board 2 for the drilling of contact bores is shown, wherein the borings connect at least a first layer 4 of the printed circuit board with contact surfaces of at least a second layer 6 of the printed circuit board to one another. The device 24 includes a device for determining a layer offset among the layers 4, 6, 8 and the other layers of the printed circuit board 2, which are not provided with a reference symbol in the drawing, wherein in this exemplary embodiment the device includes a microfocus x-ray tube 26, with which, using an imaging process, a layer offset of the layers 4, 6, 8 and the other layers of the printed circuit board 2 relative to one another can be determined. The nature and method of determining the layer offset by x-ray examination of the printed circuit board 2 is generally known to one of ordinary skill in the art and therefore will not be described in greater detail here.

According to the invention, the device 24 has a device for applying at least one reference mark to the printed circuit board 2, wherein in this embodiment this device includes a laser 28, whose laser beam can be used to apply the reference mark or reference marks to the printed circuit board 2. In this exemplary embodiment each of the reference marks is an optically detectable marking.

According to the invention the device 24 in FIG. 6 further includes a device, not shown here, for determining drilling coordinates for the contact bores in relation to the reference mark and based upon the, determined layer offset.

To prepare printed circuit board 2 for the drilling of the contact bores, the printed circuit board 2 is held fixed in space, and the layer offset of the layers of the printed circuit board 2 relative to one another is determined using the microfocus x-ray tube 26, which in this process scans the relevant surface of the printed circuit board 2. The microfocus x-ray tube is accordingly mounted such that it can be moved in an X- and a Y-direction, in other words in FIG. 6 parallel to the plane of the drawing, and into the plane of the drawing and out of the plane of the drawing.

According to the invention, using the laser 28 at least one reference mark in the form of an optically detectable marking is applied to the surface of the printed circuit board 2.

These drilling coordinates are then determined in relation to the reference mark and based upon the determined layer offset, using the device for determining drilling coordinates for the contact bores. In addition, a suitable control device can be provided, which can, for example, be equipped with a PC, and which determines the drilling coordinates in an optimized fashion, in relation to the reference mark, and based upon the determined layer offset. The determined drilling coordinates, which define the positions of the contact bores to be drilled in relation to the reference mark, can then be stored in a memory bank as the data set assigned to the printed circuit board 2.

FIG. 7 shows a plan view of the printed circuit board 2, on the surface of which, in this exemplary embodiment, three reference marks 30, 32, 34 spaced from one another are applied.

Once the printed circuit board 2 has been prepared for the drilling of the contact bores, the printed circuit board 2 can be removed from the device 24 according to the invention and placed in a drilling apparatus according to the invention.

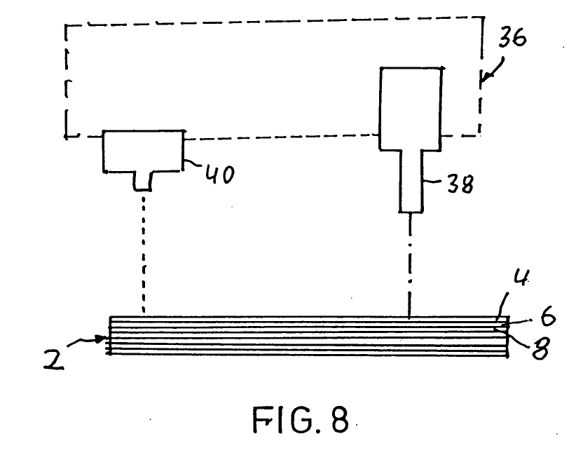

FIG. 8 is a schematic illustrating a principle of a drilling apparatus 36 according to the invention. The drilling apparatus 36 according to the invention includes a drilling device for drilling the contact bores, wherein in this exemplary embodiment the drilling device has a laser 38, with which the contact bores can be drilled with high positioning precision and high geometric precision into the printed circuit board 2.

The drilling apparatus 36 according to the invention further includes a device for detecting the position of the reference marks 30, 32, 34 applied to the printed circuit board 2, wherein in this exemplary embodiment the device includes an optical sensor, which is in the form of a CCD camera 40. The drilling apparatus 36 according to the invention shown in FIG. 8 is further equipped with a control device, not shown here, which controls the laser 38 using control signals, which contain the drilling coordinates for the contact bores in relation to the reference mark, determined in the device 24 according to the invention (see FIG. 6).

For scanning the surface of the printed circuit board 2, the CCD camera 40 and the laser 38 are mounted so as to be movable in the X- and the Y-direction, in other words parallel to the plane of the drawing, as well as into the plane of the drawing and out of the plane of the drawing.

During the process of detecting the position of the reference marks 30, 32, 34 and during the process of drilling the contact bores, the printed circuit board 2 is held fixed in space in the drilling apparatus 36.

Once the position of the reference marks 30, 32, 34 has been detected, the control device controls the drilling device using corresponding control signals, which contain the drilling coordinates for the contact bores in relation to the reference marks, such that the drilling device drills the contact bores in relation to the detected position of the reference marks 30, 32, 34.

Thus, according to the invention, the contact bores are drilled in positions that are defined in relation to the position of the reference marks 30, 32, 34, so that the positioning precision of the contact bores is dependent upon the absolute position of the printed circuit board 2 in the drilling apparatus 36. Thus according to the invention, the positioning precision of the contact bores is not affected by mechanical conditions, but exclusively by the precision of the detection of the reference marks 30, 32, 34 and the positioning precision of the laser 38. Because both the detection of the position of the reference marks 30, 32, 34 and the positioning of the laser 38 relative to the printed circuit board 2 can be highly precise, an extraordinarily high positioning precision of the contact bores is achieved in this manner.

According to the invention, the drilling coordinates that are determined in relation to the reference marks 30, 32, 34 can be used without further correction to drill the contact bores. However it is also possible according to the invention to detect position changes in the reference marks 30, 32, 34, in order to determine, for example, whether the printed circuit board 2 has shrunk or expanded following the determination of the drilling coordinates. For this purpose, the data set that is transmitted to the drilling apparatus 36 can contain, for example, information regarding the spacing of the reference marks 30, 32, 34 relative to one another or their position relative to one another. If, following the determination of the position of the reference marks 30, 32, 34 using the CCD camera 40 in the drilling apparatus 36 according to the invention, it is determined that the position of the reference marks 30, 32, 34 has changed, for example due to an expansion or shrinkage of the printed circuit board 2, the drilling coordinates can be adjusted accordingly.

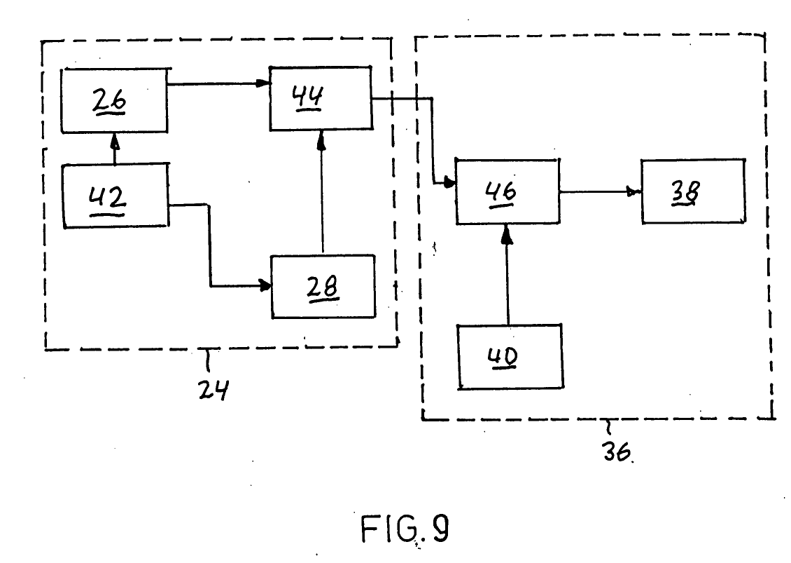

FIG. 9 illustrates a signal flow chart for a system including a device according to the invention in accordance with FIG. 6 and a drilling apparatus 8 according to the invention.

A control device 42 controls the microfocus x-ray tube for scanning the printed circuit board 2 to determine the layer offset, and the laser 28 for applying the reference marks 30, 32, 34 to the printed circuit board 2. The position of the reference marks 30, 32, 34 and the determined layer offset are transmitted to a device 44 for determining the drilling coordinates for the contact bores in relation to the reference marks 30, 32, 34 and based upon the determined layer offset. From these data, the device 44 calculates the drilling coordinates for the contact bores in relation to the reference marks 30, 32, 34 and transmits a corresponding data set to a control device 46 of the drilling apparatus 36 according to the invention. The CCD camera 40 determines the position of the reference marks 30, 32, 34 and transmits this to the control device 46, which in turn controls the laser 38 for drilling the contact bores according to the drilling coordinates in relation to the reference marks 30, 32, 34.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Device for preparing a multilayer printed circuit board for the drilling of contact bores, which contact bores connect a contact surface of at least a first layer of the multilayer printed circuit board and a contact surface of at least a second layer of the multilayer printed circuit board to one another, comprising:
a) a device provided for determining a layer offset between the first layer and the second layer of the multilayer printed circuit board;
b) a device provided for applying at least one reference mark to the multilayer printed circuit board; and
c) a device provided for determining drilling coordinates for the contact bores in relation to the at least one reference mark, in use, and based upon the determined layer offset.

2. Device according to claim 1, wherein:
a) the device for applying at least one reference mark includes at least one laser having a laser beam, the laser beam being used to apply the reference mark to the multilayer printed circuit board.

3. Device according to claim 2, wherein:
a) at least one of the at least one reference marks includes an optically detectable marking.

4. Device according to claim 1, wherein:
a) at least one of the at least one reference marks includes an optically detectable marking.

5. Device according to claim 1, wherein:
a) the device for applying at least one reference mark applies the at least one reference mark to the surface of the multilayer printed circuit board.

6. Device according to claim 1, wherein:
a) the device for determining a layer offset uses an imaging process to determine the layer offset.

7. Device according to claim 1, wherein:
a) the device for determining the layer offset has at least one x-ray measuring device for measuring the layer offset.

8. Device according to claim 7, wherein:
a) the at least one x-ray measuring device includes at least one microfocus x-ray tube.

9. Drilling apparatus for drilling contact bores for connecting contact surfaces of at least a first layer of a multilayer printed circuit board with contact surfaces of at least a second layer of a multilayer printed circuit board, comprising:
a) a drilling device provided for drilling the contact bores;
b) a control device provided for generating control signals for controlling the drilling device in accordance with the respective contact bores to be drilled;
c) a device provided for detecting the position of at least one reference mark applied to the multilayer printed circuit board; and
d) the control device controlling the drilling device using control signals, which control signals contain the drilling coordinates for the contact bores in relation to the at least one reference mark, such that the drilling device drills the contact bores in relation to the detected position of the at least one reference mark.

10. Drilling apparatus according to claim 9, wherein:
a) the device provided for detecting the position of at least one reference mark includes a sensor device having at least one optical sensor for detecting an optically detectable marking.

11. Drilling apparatus according to claim 10, wherein:
a) the at least one optical sensor includes a camera.

12. Drilling apparatus according to claim 9, wherein:
a) the drilling device includes at least one laser for drilling the contact bores.

13. System for drilling contact bores for connecting contact surfaces of at least a first layer of a multilayer printed circuit board with contact surfaces of at least a second layer of the multilayer printed circuit board, comprising:
a) a device for preparing a multilayer printed circuit board for the drilling of contact bores, which contact bores connect a contact surface of at least a first layer of the multilayer printed circuit board and a contact surface of at least a second layer of the multilayer printed circuit board to one another, the device for preparing a multilayer printed circuit board for the drilling of contact bores including:
i) a device provided for determining a layer offset between the first layer and the second layer of the multilayer printed circuit board;
ii) a device provided for applying at least one reference mark to the multilayer printed circuit board; and
iii) a device provided for determining drilling coordinates for the contact bores in relation to the at least one reference mark, in use, and based upon the determined layer offset;
b) a drilling apparatus for drilling the contact bores for connecting the contact surfaces of the at least a first layer of the multilayer printed circuit board with the contact surfaces of the at least a second layer of the multilayer printed circuit board, including:
i) a drilling device provided for drilling the contact bores;
ii) a control device provided for generating control signals for controlling the drilling device in accordance with the respective contact bores to be drilled;
iii) a device provided for detecting the position of the at least one reference mark applied to the multilayer printed circuit board; and
iv) the control device controlling the drilling device using control signals, which control signals contain the drilling coordinates for the contact bores in relation to the at least one reference mark, such that the drilling device drills the contact bores in relation to the detected position of the at least one reference mark; and
c) the device for determining the drilling coordinates for the contact bores in relation to the at least one reference mark is in signal transmission connection with the control device, and transmits to the control device a data set for a multilayer printed circuit board which is to be processed, in use, and the data set containing the drilling coordinates for the contact bores in relation to the at least one reference mark, and the control device controls the drilling device using the drilling coordinates, in use, such that the drilling device drills the contact bores in relation to the detected position of the at least one reference mark.
